(19) United States
(12) Patent Application Publication
(10) Pub. No.: US 2004/0162831 A1
(43) Pub. Date: Aug. 19, 2004

(54) Document handling system and method

(76) Inventor: John Douglas Patterson, Dayton, OH (US)

Correspondence Address: Killworth, Gottman, Hagan & Schaeff, L.L.P., One dayton Centre, Suite 500, Dayton, OH, 45402-2023, US

(21) Appl. No.: 10/359,769

(22) Filed: Feb. 6, 2003

(51) Int. Cl. G06F 7/00

(52) U.S. Cl. 707/100

(57) ABSTRACT

A document handling system and method of extracting information needed for record scanning and indexing from a database containing personal information pertaining to a person, such as a patient, at the time that a document is printed, and printing that information on the document as a machine-readable code image to facilitate later document preparation, scanning and indexing processing is disclosed.

### BACKGROUND OF THE INVENTION

The present invention relates to a system and method for the handling of documents, and more particularly to a system and method for processing documents and forms having a machine readable image code containing data or information needed for scanning and indexing, such as for example, a patient medical record.

Recent years have seen an increased expectation of confidentiality in personally identifiable information stored in computer databases. For example, the Health Insurance Portability and Accountability Act of 1996 (HIPAA) requires additional safeguards by all healthcare organizations and related entities to protect the security and confidentiality of patient identifiable information. This law establishes severe penalties for “wrongful disclosure” of health information that is individually identifiable. It has dramatically changed the way healthcare organizations conduct business, and in particular to the way healthcare organizations handle forms and documents, such as medical records. In addition, the Graham-Leach-Bliley Act of 2000 identifies the need for similar practices in the financial community, in which each financial institution has an affirmative and continuing obligation to respect the privacy of its customers and to protect the security and confidentiality of those customers' nonpublic personal information.

Forms and documents are the foundation of every business. Automating business processes associated with forms and documents have been proven to increase productivity and reduce costs. For example, “Print on Demand” software permits blank forms to be printed as needed. Such software eliminates the costs associated with storing and distributing preprinted forms. Additionally, “Print on Demand” software eliminates obsolescence and version control problems, since all personnel receive documents from one electronically updated source. However, while technology is enabling a shift away from the manually intensive total paper environment, migration can only be driven by solutions supporting a hybrid format model. This simply means supporting the varying formats knowledge workers use—paper and digital—while making the process transparent to the user.

In the current healthcare settings, blank forms and documents used to create a patient's medical record are either preprinted, or printed on demand as needed. Healthcare professionals then use these forms and documents in their normal course of business filling out the necessary patient information. Eventually the documents become part of the patient's medical record containing various forms and documents. This is managed by the Medical Records Department, who may desire to store it electronically. Converting the paper medical record document to electronic images is presently done through scanning, which is labor intensive, and therefore costly.

In some instances, each document is first reviewed and prepared for scanning by removing staples, paperclips and by inserting a cover page for each document called a target sheet. The target sheet indicates the type of document (i.e., nurse's note, physician order, lab results, etc.) This identification of document type is typically done using a series of check boxes on the target sheet. The target sheet precedes each document and as they are scanned, via a scanner which captures the image of the document, the check box identifies the document type to the scanning software, and the document is then manually indexed. Based on the document type, as specified by the target sheet, the image is viewed on-screen and specific categories of information are visually captured and keyed into the indexing system. The information captured is used for subsequent categorization and retrieval of the documents.

In other situations, as the forms and documents are scanned, an optical reader is used with character recognition software to automatically read indexing information from various fields on the forms and documents. Although, automatic indexing using optical character recognition (OCR) is an improvement over manually indexing such forms and documents, it frequently fails to deliver accurate conversions in typical forms-based document imaging applications. The forms get in the way, numbers and characters often are not clearly written, and documents are faint and sometimes dirty. Backgrounds and color interfere with the document image, and it is difficult to locate the key fields automatically on the many, variously formatted documents in use. As a result, OCR usually achieves successful recognition less than 90 percent of the time, leading to expensive manual keying of index data. Additionally, such forms and documents fail to provide additional safeguards to protect the security and confidentiality of patient identifiable information.

Accordingly, what is needed is a document handling system which provides improved automatic indexing and additional safeguards to protect the security and confidentiality of nonpublic personal information.

### SUMMARY OF THE INVENTION

In accordance with the teachings of the present invention, there is herein described and illustrated a system and method for handling documents which provides improved automatic indexing and additional safeguards to protect the security and confidentiality of nonpublic personal information through the use of a machine readable image code, such as a barcode. In particular, the preparation of documents for scanning, and the indexing of the documents by the present invention is facilitated by a print on demand software which has been modified according to the present invention. Such a print-on-demand system is, for example, the Patient Linkup° Enterprise System (PLUES), sold by The Standard Register Company, which in addition to the herein described capabilities of the present invention provides on-demand printing of labels, wristbands and forms from various blank stocks primarily offered in the healthcare market. The PLUES is connected to a conventional hospital information system (HIS). The HIS has virtually all of the information relating to a patient that would be needed to index a particular medical record document. At the time that the document is printed by the PLUES, it extracts this information from the HIS and prints it on the patient document as a machine-readable image code such as, for example, a barcode or it can output a barcode that contains a link to the database with the patient information.

After the hospital document is used in its normal fashion, medical records personnel review the document(s) when the files and/or patient chart is being closed. When the document is scanned, the indexing information is read from the barcode. After scanning, the document is processed electronically, with an operator merely reviewing an image of the document and the scan data as a check. The document image is then electronically stored in an electronic document repository along with the indexing information that is used for retrieval. Consequently, the method of the present invention allows the hospital to reduce and/or eliminate the need to out-source scanning and indexing of records off-site, thereby reducing the risk of public disclosure of nonpublic personal information, as well as, operational expenses. Additionally, since the information needed for indexing the particular type of form is printed as a machine-readable image code, added security and confidentiality of patient identifiable information is provided.

In accordance to one embodiment of the invention, provided is a document handling system. The document handling system comprises a database source storing personal information corresponding to a person, a document database storing electronic information corresponding to a document containing at least human readable information, and a code generator module adapted to generate a machine-readable image code at least based on the personal information from the database source. The document handling system further comprises an output engine module adapted to output the document with the image code; and a document indexing module adapted to read the image code, and index the document according to the personal information provided in the image code.

In accordance to another embodiment, provided is a computerized method for automatically indexing a document to a person. The computerized method comprises a personal information request module electronically retrieving from a database source information corresponding to the person, and a document database electronically providing electronic information corresponding to a document containing at least human readable information. The computerized method further comprises a code generator module generating a machine-readable image code at least based on the personal information received from the database source, and an output engine module outputting the document with the image code.

In accordance to still another embodiment, provided is a computer program product comprising computer program code recorded on a machine-readable recording medium. The program code includes instructions for implementing a personal information request module adapted to electronically request and retrieve from a database source information corresponding to a person, and a document database adapted to electronically provide electronic information corresponding to a document containing at least human readable information. The program code further includes instructions for implementing a code generator module adapted to generate a machine-readable image code at least based on the personal information received from the database source, and an output engine module adapted to output the document with the image code.

These and other more detailed and specific objects and features of the present invention are more fully disclosed in the following specification, with reference to the accompanying drawings.

### BRIEF DESCRIPTION OF THE DRAWINGS

FIG. 1 is a block diagram that shows a client computer connected to a local server computer, a network, and a remote workstation, and a router for Internet connection according to one embodiment of the present invention;

FIG. 2 is a schematic block diagram of the components of a system for providing printed documents with indexing information from a patient's data record according to the present invention;

FIG. 3 is a flowchart that describes the operation of a processing program, according to the present invention.

### DETAILED DESCRIPTION OF THE PREFERRED EMBODIMENTS

Certain embodiments of the invention are now described with reference to the Figures, where like reference numbers indicate identical or functionally similar elements. The components of the present invention, as generally described and illustrated in the Figures, may be implemented in a wide variety of configurations. Thus, the following more detailed description of the embodiments of the system and method of the present invention, as represented in the Figures, is not intended to limit the scope of the invention, as claimed, but is merely representative of certain embodiments of the invention.

As used herein, the term “document” is defined as a container of information that can be in a variety of media: paper, film, digital image, file folder, or any other media having on it a representation of thoughts by means of some conventional mark, symbol, or image.

Throughout the following description, various components of a system in accordance with the present invention are described as “modules.” In one embodiment, the modules may be implemented as software, hardware, firmware, or any combination thereof.

For example, as used herein, a module may include any type of database table, database file, database object, computer instruction, or computer executable code located within a memory device and/or transmitted as electronic signals over a system bus or network. An identified module may include, for instance, one or more physical or logical blocks of computer instructions, which may be organized as an object, a procedure, a function, a remote procedure call, or the like.

The identified modules need not be located together, but may include disparate instructions stored in different locations, which together implement the described functionality of the module. A module may include either a single instruction or many instructions. Additionally, a module may even be distributed among several discrete code segments within different programs, and across several memory devices.

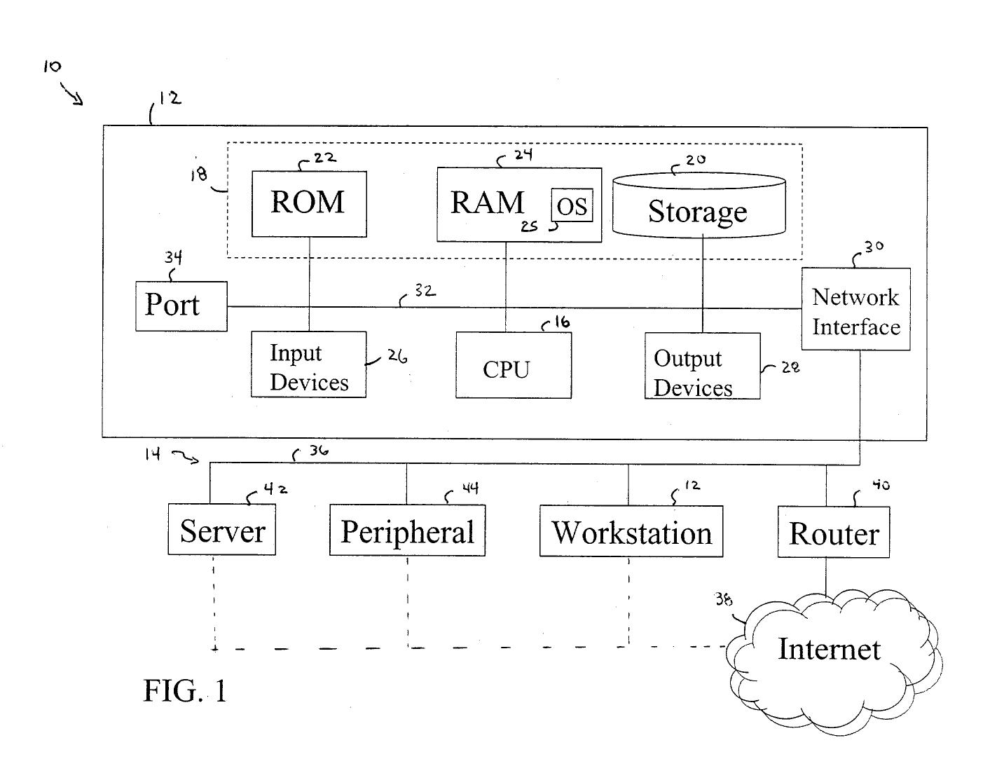

FIG. 1 is a schematic block diagram illustrating a computer system 10 in which a plurality of modules may be hosted on one or more computer workstations 12 connected via a network 14. The network 14 may comprise a wide area network (WAN) or local area network (LAN) and may also comprise an interconnected system of networks, one particular example of which is the Internet.

A typical computer workstation 12 may include a central processing unit (CPU) 16. The CPU 16 may be operably connected to one or more memory devices 18. The memory devices 18 are depicted as including a non-volatile storage device 20, such as a hard disk drive or CD-ROM drive, a read-only memory (ROM) 22, and a random access memory (RAM) 24.

Preferably, the computer workstation 12 operates under the control of an operating system (OS) 25, such as WINDOWS NT™, XP™, Windows 2000™, WINDOWS™, UNIX™, LINUX™, OS/2™, and the like. In one embodiment, the OS 25 provides a graphical user interface (GUI) to enable the user to visually interact with the modules of the present invention. In one embodiment, the OS 25 may be loaded from the non-volatile storage device 20 into the RAM 24 at the time the computer workstation 12 is booted.

The computer workstation 12 may also include one or more input devices 26, such as a mouse and/or a keyboard, for receiving inputs from a user. Similarly, one or more output devices 28, such as a monitor to permit the user to view the GUI and/ or a printer, may be provided within, or be accessible from, the computer workstation 12.

A network interface 30, such as an Ethernet adapter, may be provided for coupling the computer workstation 12 to the network 14. Where the network 14 is remote from the computer workstation 12, the network interface 30 may comprise a modern, and may connect to the network 14 through a local access line, such as a telephone line or through wireless networking technology.

Within any given computer workstation 12, a system bus 32 may operably interconnect the CPU 16, the memory devices 18, the input devices 26, the output devices 28, the network interface 30, and one or more additional ports 34, such as USB, parallel ports and/or RS-232 serial ports.

The system bus 32 and a network backbone 36 may be regarded as data carriers. Accordingly, the system bus 32 and the network backbone 36 may be embodied in numerous configurations, such as wire and/or fiber optic lines, as well as “wireless” electromagnetic links using visible light, infrared, and radio frequencies.

The computer workstations 12 may be coupled via the network 14 to application servers 42, and other resources or peripherals 44, such as scanners, digital cameras, fax machines, and the like. External networks, such as Internet 38, may be coupled to the network 14 through a router 40 or firewall. In general, the network 14 may comprise a single local area network (LAN), a wide area network (WAN), several adjoining networks, an intranet, an extranet, or as in the manner depicted, a system of interconnected networks such as the Internet 38. The servers 42, peripheral 44, and individual computer workstations 12 may communicate with each other over the backbone 36 and/or over the Internet 38 using various communication techniques.

For instance, different communication protocols, e.g., ISO/OSI, IPX, TCP/IP, may be used within the network 14. In the case of the Internet 38, however, a layered communications protocol (i.e. TCP/IP) generally best enables communications between the differing networks 14, servers 42, and computer workstations 12.

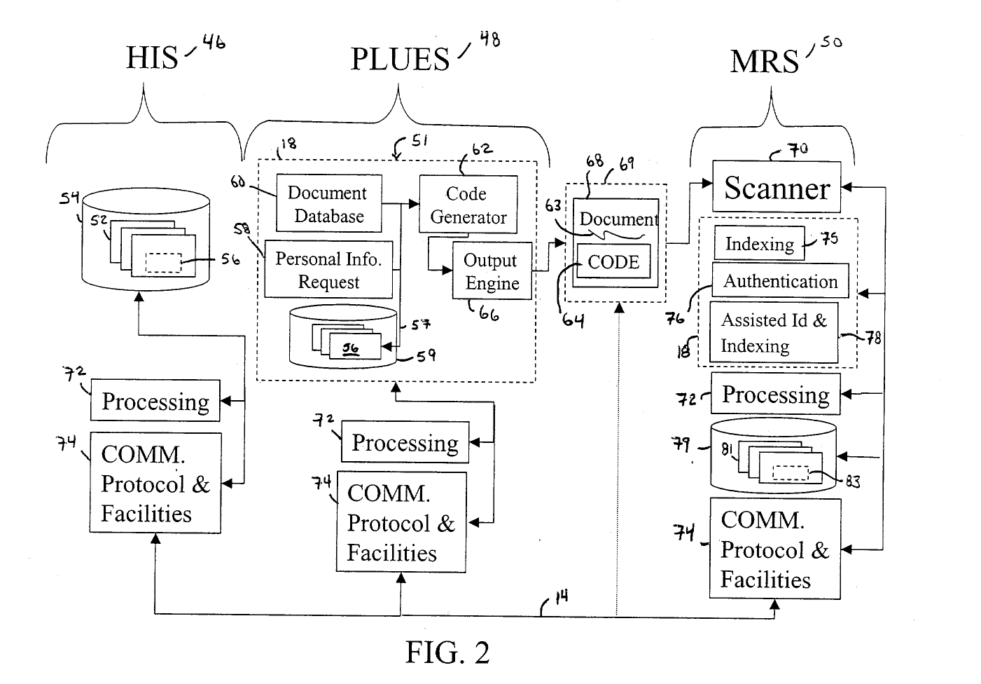

Referring now to FIG. 2, provided for illustration purposes is one embodiment of the present invention advantageously implemented in the healthcare setting. The integration between a healthcare or hospital information system (HIS) 46, a print-on-demand system, such as for example, Standard Register's Patient Linkup® Enterprise System (PLUES) 48, and a record storage system, such as for example, a medical records system (MRS) 50 is illustrated by a schematic block diagram of the components of the present invention. This integration conveniently provides printed patient documents with a machine-readable image code containing indexing information extracted from a patient's data record located in the HIS 46. As will be explained more fully below, this indexing information is used in the present invention to improve indexing accuracy, maximize ease of use, and achieve higher productivity.

In particular, the memory devices 18 of the FIG. 1 are depicted as storing therein a system 51 for indexing printed patient documents with preselected information extracted from a patient's data records 52 contained in the HIS 46. The data records 52 of the HIS 46 may be stored within an input database 54 or other, suitable location. The input database 54 may comprise, for example, a conventional relational database management system (RDBMS), such as one available from ORACLE™, SYBASE™, or the like. In alternative embodiments, the input database 54 may comprise a flat file, a table, database object, or other conventional data structure.

In one embodiment, each data record 52 includes a plurality of indexing elements 56 associated with an individual to whom the record 52 pertains. The indexing elements 56 may include, for example, a name, a birth date, an address, a ZIP code, a telephone number, a healthcare identifier, and the like. A variety of different or additional indexing elements 56 may be provided within the scope of the invention.

In certain embodiments, the system 51 includes a plurality of modules containing executable code for performing the methods described herein. Although the modules are illustrated as separate functional units, the various modules may be combined or integrated into a single software application or device. Likewise, the functionality of any one module may be implemented using two or more modules.

In one embodiment, the system 51 includes a personal information request module 58, which makes requests to the HIS 46 for indexing information and maintains in memory 18 the received plurality of indexing elements 56 for identifying an individual to whom the record 52 pertains. The system 51 further comprises document database 60, which electronically stores a version of each form and each document used in the particular healthcare organization. Document database 60 may also include descriptions and indexing instructions for each form and document contained therein for purposes of at least one of identification, authentication and processing control.

The system 51 further includes a code generator module 62 to create a machine-readable image code 64 having sufficient information density and capacity to encode the information content of at least the received plurality of indexing elements 56 or a unique identifier 57, which links to an indexing database 59 containing the plurality of indexing elements 56. The image code 64 may also include the informational content passed to the code generator module 62 by document database 60 when a document is selected for reproduction. An example of this image code 64 suitable for use with the present invention is a one or two-dimensional barcode. A document may also contain more than one barcode with one barcode identifying the document type and the second barcode containing the plurality of indexing elements 56 or the unique identifier 57.

The system 51 further comprises an output engine module 66 to generate in one embodiment a desired unfilled document or form 68 containing human readable information 63, appropriate spaces for the entry by hand of additional information regarding, for example, a medical test or procedure, and a machine-readable barcode 64. In other embodiments, the output engine module 66 may provide the document 68 with barcode 64 as a fax, e-mail, web page, or combinations thereof. The barcode 64 includes information which is stored in the HIS 46 and which would be used ultimately for indexing the document or form 68.

In another embodiment, the present invention may combine information extracted from the HIS 46 to create a document 68 with the human-readable information 63 partially completed or filled-in, with spaces for entry by hand of additional information, and having the barcode 64. In still another embodiment, the document 68 (partially filled or not filled with human readable information) may be electronically provided by output engine module 66 with the barcode 64 to a separate electronic device 69, such as a tablet PC, personal digital assistance (PDA), other handheld computing devices (e.g., cell phone, notebook PC, etc.), and/or another workstation 12.

In still other embodiments, the encoded information of the barcode 64, in addition to the plurality of indexing elements 56 or the unique identifier 57, may include at least one of a document identifier, version number, date, and other relevant information to enable the MRS 50 to electronically identify the document 68. Other information may indicate the doctor's name, the network address of the PLUES 48 generating the document, and other information useful to identify the authenticity or validity of the document 68. The information contained in the barcode 64 may be encrypted, as well.

In one embodiment, encryption is accomplished using software in the code generator module 62 such as, for example, exclusive-ORing the plurality of indexing elements 56 received by the system 51 with a pseudo-random sequence generated using a secret key as a seed. Note that in this case, the decryption then performed by the MRS 50 is simply exclusive-ORing the encrypted information contained in the barcode 64 provided with the printed document with the same pseudo-random sequence. In another embodiment, encryption processing in the code generator module 62 and MRS 50 could be performed using the digital encryption standard (DES) or the RSA algorithm. In the RSA algorithm, digital data is encrypted using two prime numbers which are multiplied together, as is well-known in the art. However, it should be noted that any digital encryption method may be employed with the present invention.

After using the document 68 in the normal course of business, the document 68 is then sent to the hospital's Medical Records Department for preparing, scanning, indexing, and storing in an electronic document repository. Before storing the document 68 in the electronic document repository, however, the document is automatically indexed by the MRS 50 so that it can be located later and retrieved. The MRS 50 includes a scanner 70 for scanning the document 68 and barcode(s) 64 and a module to read the bar code(s) on the document. In one embodiment, the barcode(s) 64 contains the unique identifier 57 which the MRS 50 uses to extract the plurality of indexing elements 56 linked in the indexing database 59.

In another embodiment, the barcode(s) 64 contains at least the plurality of indexing elements 56. In still other embodiment, in addition to either the unique identifier 57 or the plurality of indexing elements 56, the barcode(s) 64 contains data or provides a pointer or link to/or the document type information contained in document database 60. The MRS 50 uses this information provided in the barcode(s) 64 and/or extracted from the indexing database 59 and/or document database 60 to index the content (including at least one of text, data, an image type, and hand-entered information) provided on the document 68. The MRS 50 may include recognition software, e.g., hand writing recognition software, to interpret information on the document 68, such as signatures and other hand-entered information.

The MRS 50, as well as the HIS 46 and the PLUES 48, includes intelligent processing 72 and communication facilities 74 that enable the MRS 50 to contact the PLUES 48 based on the information scanned in order to verify and authenticate the document and the index data read from barcode 64. Alternatively, the index data read from barcode 64 may be also verified by the MRS 50 contacting HIS 46. The communications facilities 74 transmit and receive signals between systems 46, 48, and 50 via network 14. The communications facilities 74 may include query software that receives data, deciphers data, and searches and responds to queries to and from the HIS 46 and the PLUES 48. The MRS 50 may comprise a computer system similar to that of the PLUES 48 with additional scanning software and hardware to carry out the automatic indexing process of the present invention.

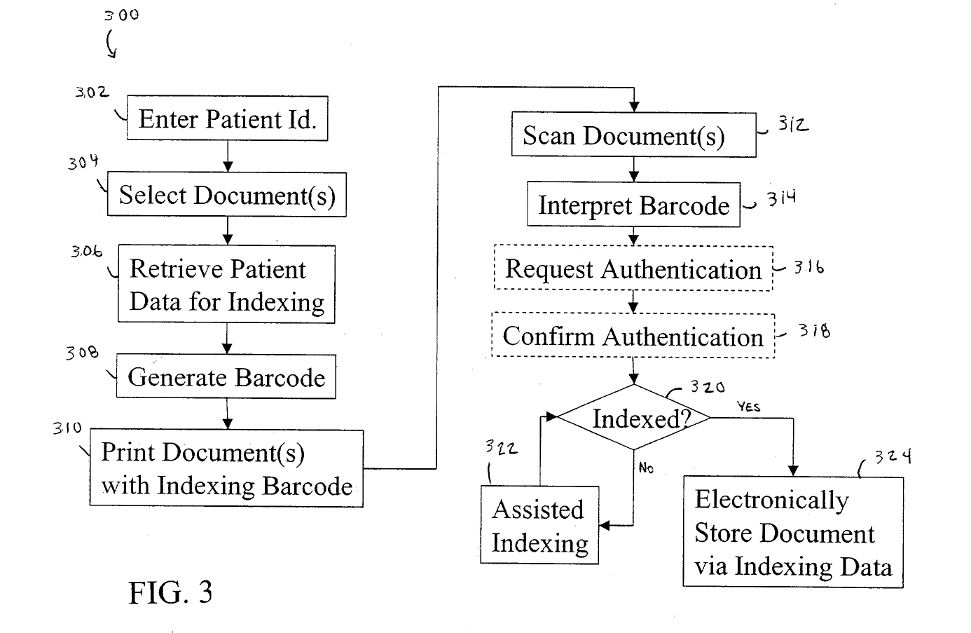

The automatic indexing process 300 of the present invention is summarized in the flow chart in FIG. 3. Referring to FIGS. 2 and 3, initially a user desiring to generate a desired document 68 for a patient will use the PLUES 48 and enter the patient's name or identification number in step 302 or select the patient name or identification from a list or be provided the information by the HIS 46. The user will then select the document 68 that is to be printed in step 304. It is to be appreciated that this document selection may provide a plurality of documents and forms as part of a standardized admission package, or in preparation for a medical procedure, with the selection of the particular document or documents being made from an electronic menu. In some cases the documents output may be determined by business rules contained in PLUES 48 that are triggered by inputs from the HIS 46, automatically generating the needed documents 68.

In step 306, the PLUES 48 requests from the HIS 46 the information needed to index the particular documents that were selected in the previous step. In processing step 308, the PLUES 48 generates the barcode 64 with either the received indexing elements 56 from the HIS 46 or with the unique identifier 57 linking to the received indexing elements 56 stored in indexing database 59 and, optionally, with the information received from the document database 60 identifying the document(s) 68. Optionally, an image copy of the generated barcode 64 may be stored in the PLUES 48 for authentication purposes, if desired. In processing step 310, the PLUES 48 outputs the document 68 having both human-readable information 63 and the machine-readable indexing barcode 64. The document 68 is then provided to the user, e.g. nurse, doctor, or technician, for use in the normal course of treatment of the patient.

For example, a patient medical progress chart may be generated by the system 51 of the present invention containing the barcode(s) 64. In one illustrated implementation, the barcode 64 has imbedded in it indexing information obtained from the patient's information (for example, name, address, social security number, billing rate, insurance information and the like) provided in the HIS 46. Optionally, the barcode 64 may also contain information, such as the type of document, number of pages of the record, and the like. In another implementation, the barcode 64 may contain the unique identifier 57 which links or points to the database record, table, or object in the indexing database 59 which contains such indexing information.

After the document 68 is used in the normal course of business, it is sent to the Medical Records Department for conversion and electronic storage in a document repository, such as database 79 of the MRS 50. At that time, the document 68 is scanned, via scanner 70, in processing block 312, which can be completed individually or via a batch job. In a printed embodiment, the indexing barcode 64 provided on document 68 can be scanned by a page scanner, and/or a high resolution fax machine. In an electronic embodiment, the indexing barcode 64 can be electronically read from Internet forms (HTML, XML, Java, etc), files from office software applications, EDI, or spools of the associated document 68. The type of document will be determined and the necessary indexing information is read from the barcode 64 or extracted from indexing database 59 to index the document 58. An operator may review the indexing information on a monitor and confirm that it is correct or, if need be, correct the erroneous indexing information and confirm the correct information.

In processing block 314, an indexing module 75 running in system memory 18 of the MRS 50 interprets the machine-readable information contained in the barcode 64 and uses that information to electronically index the scanned document 68. Optionally, in processing blocks 316 and 318 the MRS 50 verifies the authenticity of the document 68. For such processing, the MRS 50 can contact the HIS 46 or the PLUES 48 to request verification of the information contained in the barcode 64 (processing block 316), if desired. In such instances, the HIS 46 and/or PLUES 48 either verifies the information contained in the barcode 64 if sent by the MRS 50 or sends a copy of the stored barcode image to the MRS 50 for comparison (processing block 318), or vice versa. Processing blocks 316 and 318 are completed automatically without human intervention.

Processing blocks 316 and 318 can be used to confirm the accuracy and authenticity of patient indexing information scanned, and possibly the validity and authenticity of the scanned document(s) 68 themselves. For example, an automatic authentication-processing module 76 can enable the validity of the data recognized on one document, or document folder, to be checked according to predetermined logical rules. Another example is to confirm that the document 68 is in the correct medical record folder, by comparing a unique identifier of the folder to the identifier on the document. Such logical rules include, for example, the number of pages in the particular document 68, particular field attributes, e.g. number of characters, and processing attributed, e.g. processing of check digit in a customer ID number, and the like. Such information can be provided in the barcode 64 as part of the document information provided by the document database 60 for encoding in processing block 308.

Processing blocks 320 and 322 may optionally be included in the process. Instead of displaying each document and manually confirming the indexing operation, as is discussed above in respect to processing block 312, the document may be scanned completely automatically without manual confirmation in processing block 312. Subsequently, then in processing block 320, the MCS 50 checks to see if the scanned document has an index. In this manner, only documents not indexed automatically, or which fail the validation checks, are then processed in an assisted identification and indexing module 78 in processing step 322.

Module 78 displays to the user the original document 68, the provisionally identified document type and/or field entries, and the provisionally recognized indexing data. The user then electronically verifies or corrects the data recognized by the MRS 50. The assisted identification and indexing module 78 also makes available in human readable form the information content on the document 68 which is usable for review of the information content, revision of the information content, or replacement of the information content, if desired.

In processing block 324, after automatic indexing or assisted indexing, the scanned document 68 is then electronically stored as a document image 81 in the document repository database 79, or other suitable database, such as database 54 of the HIS 46, indexing database 59 of PLUES 48, or any third party database networked thereto. It is to be appreciated that each document image 81 is provided with an index 83 in accordance with the information contained in the machine readable image code 64. After documents 68 have been electronically scanned and stored, the MRS 50 can route document images 81 and information extracted therefrom in a format that is compatible with any customer computing applications, databases, and electronic document management or workflow systems, which permits analyst and others to correct document inaccuracies and deficiencies.

An additional benefit of the present invention is that it replaces manual processing, and thereby eliminates preliminary document sorting and preparation, and reduces or eliminates manual document indexing. As an essential entry point to electronic document management software, the present invention also makes it possible to combine increased productivity, immediate availability of documents in a document management or workflow system, and higher levels of customer service.

For those documents not outputted from the PLUES 48, the PLUES, or a print-on-demand module, can output bar coded labels which when affixed to the documents and scanned will allow such documents to be indexed. A manual indexing step to identify the document type may be required, which could be accomplished using a target sheet identifying the document type prior to scanning or after scanning in the indexing review process. Another option for those documents not outputted from the PLUES 48, the PLUES, or a print-on-demand module, can output bar coded target sheets which proceed the documents and when scanned will allow such documents to be indexed. A manual marking on the target sheet could also be read by the MRS 50 or scanning module to determine the document type.

While the system 51 and method 300 of certain embodiments of the invention are described in the context of a healthcare setting, various other industries may benefit from the principles disclosed herein. Similar benefits may be realized in the financial and banking industry, in the insurance industry, in the travel industry, and a variety of other industries that have access to electronically stored nonpublic personal information pertaining to a large number of individuals needing automatic indexing. Additionally, the system 51 and method 300 of the present invention may be implemented by control circuitry using logic gates, programmable logic devices, or other hardware components in lieu of a processor-based system.

It is important to note that while the present invention has been described in the context of a computer system, that those skilled in the art will appreciate that the mechanisms of the present invention are capable of being distributed among various networked systems and as a program product in a variety of forms. Additionally, those skilled in the art will appreciate that the present invention applies equally regardless of the particular type of signal bearing media used to actually carry out the processing and distribution. Examples of signal bearing media include: recordable type media such as floppy disks and CD-ROMs and transmission type media such as digital and analog communications links.

The described embodiments are to be considered in all respects only as illustrative and not restrictive. The scope of the invention is therefore indicated by the appended claims rather than by the foregoing description.

What is claimed is:

1. A document handling system for indexing information related to a person, comprising:
a database source storing personal information corresponding to the person;
a document database storing electronic information corresponding to a document containing at least human readable information;
a code generator module adapted to generate a machine-readable image code at least based on said personal information from said database source;
an output engine module adapted to output said document with said image code; and
a document indexing module adapted to read said image code, and index said document according to said personal information provided in said image code.

2. The document handling system defined in claim 1, wherein said database source is a healthcare information system, a financial database system, a banking database system, or an insurance database system.

3. The document handling system defined in claim 1, wherein said document database is a memory component of a print-on-demand document system.

4. The document handling system defined in claim 1, wherein said code generator module is a memory component of a print-on-demand document system.

5. The document handling system defined in claim 1, wherein said output engine module is a memory component of a print-on-demand document system.

6. The document handling system defined in claim 1, wherein said document indexing module is a memory component of a record storage system.

7. The document handling system defined in claim 1, wherein said document database further stores electronic information for validating said document.

8. The document handling system defined in claim 1, wherein said document database further stores electronic information for validating said document, and said machine-readable image code is further based on said electronic information for indexing and validating said document.

9. The document handling system defined in claim 1, further comprises:
an authentication module that requests authentication of information contained in the machine-readable image code after being read from the document; and
a communication network coupled to the authentication module and the database source and/or said document database for exchanging information therebetween to provide such authentication and indexing of information.

10. The document handling system defined in claim 1 wherein the machine-readable image code is a bar code.

11. The document handling system defined in claim 1 wherein the machine-readable image code is a bar code of encrypted information.

12. The document handling system defined in claim 1 wherein the machine-readable image code is a one or two-dimensional barcode.

13. The document handling system defined in claim 1, wherein said output engine is adapted to output said document as a printed document, fax, e-mail, web page, or combinations thereof.

14. The document handling system defined in claim 1, wherein said output engine is adapted to output said document in electronic form.

15. The document handling system defined in claim 1, wherein said document indexing module reads said image code via a document scanner or from a scanned image.

16. The document handling system defined in claim 1, further comprising a document repository, said document being electronically stored in said document repository in accordance with the indexing of said document.

17. The document handling system defined in claim 1, further comprising a request module adapted to make requests to said database source to retrieve a plurality of indexing elements from said information corresponding to the patient index information.

18. The document handling system defined in claim 1, further comprising an assisted identification and indexing module adapted to recognize indexing data contained in said image code and permitting a user to verify and correct said indexing data to index said document properly.

19. The document handling system defined in claim 6, wherein said record storage system is a medical records system.

20. The document handling system defined in claim 1, further includes a communications network coupled at least to a medical records system, a healthcare information system and/or a print-on-demand system to exchange data regarding the person or the document therebetween.

21. The document handling system defined in claim 1 wherein said document indexing module is a memory component of a medical records system which comprises a document scanner to read the document, processing to interpret the information contained in the machine readable image code(s), and a communication interface for sending queries to said document database and said database source and receiving responses to those queries from the document database and the database source.

22. The document handling system defined in claim 1 wherein said personal information includes a unique identification number and indexing information is accessed from an indexing database using said unique identification number.

23. The document handling system defined in claim 22 wherein said indexing database is a component of a print-on-demand system.

24. A computerized method for automatically indexing a document to a person, said method comprising:
electronically retrieving from a database source information corresponding to the person by using a personal information request module;
electronically providing electronic information corresponding to a document containing at least human readable information by using a document database;
generating a machine-readable image code at least based on personal information received from said database source by using a code generator module; and
outputting said document with said image code by using an output engine module.

25. The computerized method defined by claim 24 further comprising:
scanning information content provided of the document by using a document scanner; and
reading said machine-readable image code by using an indexing module, and automatically indexing said document for storage in a document repository using said personal information contained in said machine-readable image code.

26. The computerized method defined by claim 25 wherein using said patient information includes linking to the database source or an indexing database with a unique identifier contained in said personal information to extract indexing information used to index the document.

27. The computerized method defined by claim 24 further comprising:
requesting authentication of the personal information contained in the image code by using a first communications module coupled to a network; and
providing authentication of said personal information contained in said image code in response to information provided by the first communication module by using a second communications module coupled to said network.

28. The computerized method defined in claim 27 wherein authentication comprises comparing the personal information contained in said image code provided on the document with the personal information stored in said database source.

29. The computerized method defined in claim 24 further comprising storing an electronic copy of the scanned and indexed document.

30. The computerized method defined in claim 24 wherein said output engine is configured to output said document containing said machine-readable image code as one of the following: a printed representation of said document, and an electronic representation of said document.

31. The computerized method as defined by claim 25 further comprising making available in human readable form the information content provided on said document, which is usable for one of: review of said information content, revision of said information content, and replacement of said information content, by using an assisted identification and indexing module.

32. The computerized method as defined by claim 31 wherein said information content includes said image code and at least one of text, data, an image, hand-entered information, identification information, authentication information, and processing control information.

33. The computerized method as defined by claims 24 wherein said code generator generates a one or two-dimensional barcode.

34. A computer program product comprising computer program code recorded on a machine readable recording medium, the program code including instructions for implementing:
a personal information request module adapted to electronically request and retrieve from a database source information corresponding to a person;
a document database adapted to electronically provide electronic information corresponding to a document containing at least human readable information;
a code generator module adapted to generate a machine-readable image code at least based on personal information received from said database source; and
an output engine module adapted to output said document with said image code.
